(19) United States
(12) Patent Application Publication
(10) Pub. No.: US 2003/0158865 A1
(43) Pub. Date: Aug. 21, 2003

(54) Managing multiple data stores

(76) Inventors: Frank Renkes, Rauenberg (DE); Wolfgang Degenhardt, Spiesen-Elversberg (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/330,689

(22) Filed: Dec. 27, 2002

Related U.S. Application Data
(60) Provisional application No. 60/346,765, filed on Dec. 28, 2001.

(51) Int. Cl. G06F 12/00

(52) U.S. Cl. 707/200

(57) ABSTRACT

Systems, methods, and apparatus, including computer program products, for accessing data objects stored in multiple repositories. A repository framework includes a plurality of repository managers. Each repository manager is configured to provide access to an associated repository. The repository framework includes a uniform interface for accessing the data objects, and provides a unified name space with a unique reference for each data object. Each repository manager may include a plurality of sub-managers adapted to map operations in the uniform interface to repository-specific operations. A repository manager may enhance the functionality of a repository by implementing an operation in the uniform interface for which there is no corresponding repository-specific operation. Some implementations enable users to access data objects without knowing the location, type, or format of the data objects. The benefits provided by a central repository may thus be realized without necessarily having to move data objects from their individual repositories.

### CROSS-REFERENCE TO RELATED APPLICATION

This application claims priority to U.S. Provisional Application No. 60/346,765, entitled “Repository Framework,” which was filed on Dec. 28, 2001. The disclosure of the above application is incorporated herein by reference.

### BACKGROUND

The present application relates to data objects, and more particularly to stores of data objects.

Companies and organizations tend to accumulate numerous electronic files, documents, and other data objects. Such data objects are typically stored in a repository. As a company or organization grows and data objects proliferate, the number of repositories in the company or organization is likely to increase. For example, a company may decide to establish one or more repositories for data objects of a particular type (e.g., data objects that have a particular format or that pertain to particular content).

Although an increase in the number of repositories may improve the overall scalability of a system, such an increase is likely to make it more difficult for users of the system to access the particular data objects they need. For example, before a user can access a particular data object, he may need to look up the name or location of the repository in which the data object is stored. The user may also need to look up the interface through which the data objects in that repository can be accessed, so that he can invoke the proper operations to access the data object of interest.

One approach that has been tried to address these concerns is to implement a central repository that stores all of the available data objects. Although this approach typically requires the movement of the data objects from their individual repositories into the central repository, it may provide several advantages, including facilitating a well-known, central location in which to find the data objects, as well as a uniform interface for accessing the data objects.

### SUMMARY

The systems and techniques described herein may be used to combine the advantages provided by a central repository with the advantages of a system in which data objects can be stored in multiple disparate repositories. A knowledge management system may include multiple repositories. A repository manager may be provided for each individual repository. The repository managers may control the operation of the individual repositories and may provide access to the data objects in the repositories through a uniform interface and a unified name space. The benefits provided by a central repository may thus be realized without necessarily having to move data objects from their individual repositories.

In one aspect, the invention features a knowledge management system including a plurality of repositories with data objects, and a repository framework with a plurality of repository managers. Each repository manager is configured to provide access to an associated repository. The repository framework includes a uniform interface for accessing the data objects in the repositories, and provides a unified name space with a unique reference for each data object.

Advantageous implementations may include one or more of the following features. The uniform interface may include an operation. At least one repository may include a repository-specific operation that corresponds to the operation in the uniform interface. The repository manager that is associated with the at least one repository may be adapted to map the operation specified in the uniform interface to the corresponding repository-specific operation. The operation specified in the uniform interface may be a name space operation, a property operation, a content operation, a locking operation, a versioning operation, or a security operation.

The uniform interface may include a plurality of operations. At least one repository may include a repository-specific interface with a plurality of repository-specific operations. The repository manager that is associated with the at least one repository may include a plurality of sub-managers. Each sub-manager may be adapted to map at least one operation specified in the uniform interface to at least one repository-specific operation in the plurality of repository-specific operations.

At least one repository may include a repository-specific interface with a plurality of repository-specific operations. The uniform interface may include an operation that does not correspond to any operation in the plurality of repository-specific operations. The repository manager that is associated with the at least one repository may include an implementation of the operation in the uniform interface that does not correspond to any operation in the plurality of repository-specific operations.

The data objects may be organized into at least two collections. The collections may be arranged in a hierarchy. The data objects may include structured documents, unstructured documents, semi-structured documents, or a combination thereof.

In another aspect, the invention features a machine-readable medium and method for providing access to data objects stored in a plurality of repositories. A unique reference in a unified name space is associated with each data object. A repository manager is provided; the repository manager provides access to an associated repository. A request to access a data object in one of the repositories is received. The request includes the unique reference associated with the data object. The repository in which the data object is stored is determined, based on the unique reference specified in the request. The request is dispatched to the repository manager that is associated with the repository in which the data object is stored.

Advantageous implementations can include one or more of the following features. A uniform interface for accessing the data objects may be provided. The uniform interface may include a plurality of operations. The request may specify one of the operations in the uniform interface.

The repository in which the data object is stored may include a plurality of repository-specific operations. The operation specified in the request may be mapped to at least one operation in the plurality of repository-specific operations.

At least one repository may include a plurality of repository-specific operations. The uniform interface may specify an operation that does not correspond to any operation in the plurality of repository-specific operations. The operation specified in the uniform interface (i.e., the operation that does not correspond to any operation in the plurality of repository-specific operations) may be implemented for the at least one repository.

The data objects may be organized into at least two collections. The collections may be arranged hierarchically. An eventing mechanism may be provided to enable the repository manager to trigger an event.

These general and specific aspects may be implemented using a system, a method, a computer program, or any combination of systems, methods, and computer programs.

The systems and techniques described herein may be implemented to realize one or more of the following advantages. Data objects may be accessed through a unified name space. The unified name space may provide a global hierarchy that allows users to access data objects independently of their location. For example, a user may access and move a data object (e.g., a document) in the global hierarchy without even knowing that the physical location of the data object may be moved from one repository (e.g., a file server) to another repository (e.g., a Web server).

The systems and techniques described herein may also be used to provide access to data objects through a uniform interface. Users may access data objects through the operations specified in the uniform interface, which may relieve the users from the need to look up or memorize the details of repository-specific operations. Repository managers may automatically translate access requests from operations in the uniform interface to corresponding repository-specific operations.

Users may also be able to access data objects and their content without knowing the type or format of the data objects. A user may simply request the content of a data object through a uniform operation that returns the type or format of the content as well as the content itself; that information can then be used to launch an appropriate application to display the content.

The systems and techniques described herein may also be used to provide enhanced functionality for repositories. For example, a repository such as a file system may not have any built-in security features. In such a situation, a repository manager may, for example, implement access control lists to control access to the data objects in the file system. The repository manager may provide such functionality transparently through a uniform interface.

One implementation may achieve all of the above advantages. Details of one or more implementations are set forth in the accompanying drawings and in the description below. Other features and advantages may be apparent from the description and drawings, and from the claims.

### BRIEF DESCRIPTION OF THE DRAWINGS

These and other aspects will now be described in detail with reference to the following drawings.

FIG. 1 shows a block diagram of multiple repositories.

FIG. 2 shows a block diagram of a central repository.

FIG. 3 shows a block diagram of a repository framework.

FIG. 4 shows a block diagram of a repository manager.

FIG. 5 shows a user interface.

FIG. 6 shows a flowchart of a process for providing access to data objects.

Like reference symbols in the various drawings indicate like elements.

### DETAILED DESCRIPTION

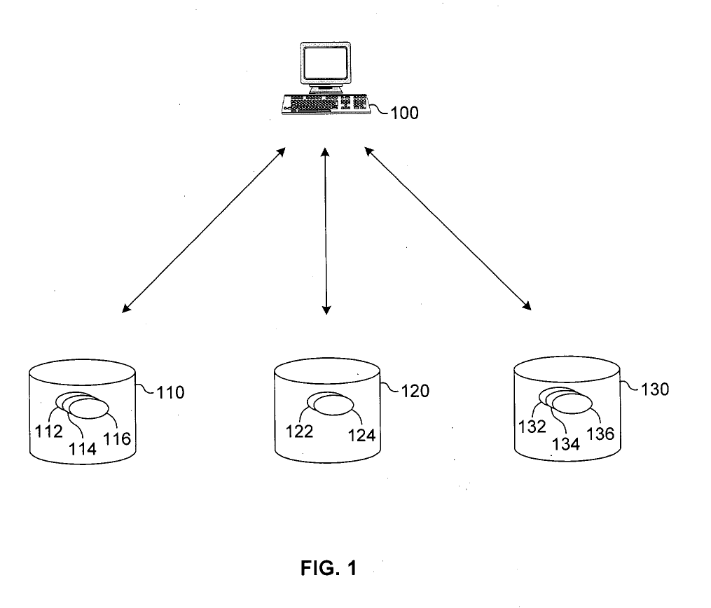

FIG. 1 depicts multiple data objects 112, 114, 116, 122, 124, 132, 134, and 136. A data object may be any type of electronic document, file, or other item that stores electronic data. As used herein, the terms “electronic document” and “document” mean a set of electronic data, including both electronic data stored in a file and electronic data received over a network. An electronic document does not necessarily correspond to a file. A document may be stored in a portion of a file that holds other documents, in a single file dedicated to the document in question, or in a set of coordinated files. Data objects may be, for example, word processing documents, program source files, program object files, Hypertext Markup Language (HTML) files, graphics files in various formats such as Joint Photographic Experts Group (JPEG) or Graphic Interchange Format (GIF), Portable Document Format (PDF) documents, multimedia files such as Motion Picture Experts Group Audio Layer-3 (MP3) files, or links to other data objects. Data objects may store structured data (e.g., database records that are stored in a specific format and sequence), unstructured data (e.g., word processing documents that may contain a mixture of text, graphics, formatting commands, and links), and semi-structured data (e.g., Extensible Markup Language (XML) documents that may contain a combination of structured information such as markup tags and unstructured information such as text data).

The data objects in FIG. 1 are stored in three repositories 110, 120, 130. A repository may be any component that stores data objects. A repository may be configured to store a particular types of data objects, for example, data objects that are of a particular format or type or that pertain to some particular content. Examples of repositories include mail servers, Web servers, file systems, database systems, documentation systems, and Lightweight Directory Access Protocol (LDAP) systems.

A repository may be used to store the content of data objects as well as meta-data associated with the objects. Meta-data may specify various properties and other information about a data object, such as the format and length of the data object, an indication of the last time the data object was accessed or modified, or a list of users who are authorized to access the data object.

A user may access the data objects shown in FIG. 1 through a user computer 100. The user computer 100 and the repositories 110, 120, 130 are typically connected through a computer network. The user may execute a program on the user computer 100 such as an application, a browser, or a portal that enables the user to access data objects.

Because the data objects in FIG. 1 are stored in multiple repositories, the user may need to specify the location of a data object before he can access that data object. For example, data object 116 is stored in repository 110. In order to access data object 116, the user may need to look up the location of that particular data object (in this case, repository 110), and send a request from user computer 100 to repository 110 for the data object.

Moreover, the user may also need to look up information about the interface for repository 110 before sending the request to access the data object 116. This is because the repositories 110, 120, and 130 may require different operations for accessing data objects. For example, the table below shows the different operations or functions that a user may invoke in order to determine the last time an object was accessed:

TABLE 1

| | function name | input parameters | value returned |
|---|---|---|---|
| repository 110 | get_access_time(); | string Name | string |
| | | | DDMMYY |
| repository 120 | last_access(); | integer Id | string |
| | | | MMDDYYYY |
| repository 130 | get_last_access(); | integer Id, | integer Z |
| | | integer User | |

In the example in Table 1, each repository 110, 120, 130 requires the invocation of a different function in order to determine the last access time for a data object: get_access_time( ) for repository 110, last_access( ) for repository 120, and get_last_access( ) for repository 130. Furthermore, each function takes different input parameters and returns different values. The function for repository 110, for example, takes one input parameter—a string that denotes the name of the data object to be accessed. The function for repository 120 also takes one input parameter—an integer that references the data object to be accessed. Presumably the user either knows the integer reference of the relevant data object, or else the user can invoke a separate operation to determine such a reference based on another value such as the name of the data object. And in contrast to the functions for repositories 110 and 120, the function for repository 130 takes two input parameters—an integer reference to the data object to be accessed, and another integer that represents the user's identification. In this example, the function for repository 130 will only return the requested information if the user is permitted to access the requested object.

Although all three functions in this example provide the time of last access for a specific data object, the functions may return different values. In the example shown in Table 1, the function for repository 110 returns a six-character string where the first two characters represent the day, the next two characters represent the month, and the last two characters represent the year. The function for repository 120 returns an eight-character string where the first two characters represent the month, the next two characters represent the day, and the last four characters represent the year. And the function for repository 130 returns an integer that may indicate, for example, a date and time in the serial format used by the Microsoft Excel program.

Thus, before a user can determine the last time a particular data object was accessed, he may need to determine the location of the object, the name of the function to invoke, and the number and format of that function's input and output parameters.

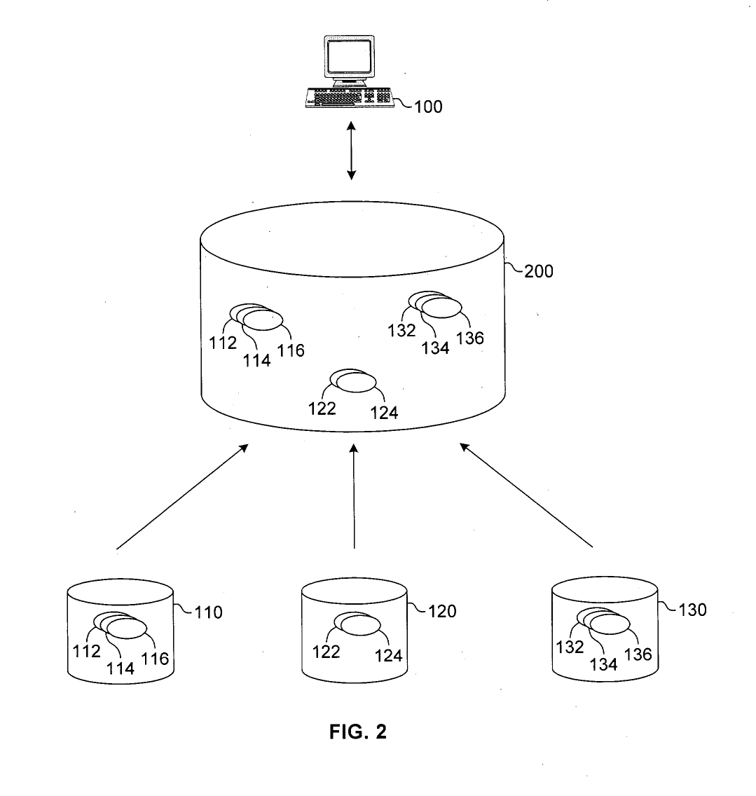

FIG. 2 shows an alternative system for storing and accessing data objects. The system in FIG. 2 features a large central repository 200. In the system in FIG. 2, the data objects in the repositories 110, 120, and 130 must be moved to the central repository 200. It may be possible to copy rather than move the data objects, but that may create consistency problems. For example, if the data object 112 is modified in the repository 112, the modifications would need to be propagated to the copy of data object 112 in the central repository 200.

Storing all of the data objects in the central repository 200 may address some of the concerns with the system in FIG. 1. For example, users may not need to look up the location of data objects, since all of the data objects are stored in one location. Moreover, the central repository 200 may provide a uniform interface for accessing data objects, thereby enabling users to use the same operations to access all the data objects.

The system in FIG. 2 may raise a different set of concerns, however. For example, scalability may be an issue in a system with one central repository. The central repository 200 may have limited bandwidth for accessing data objects, which may result in increased contention among users as the number of users grows. Moreover, the “owners” of the individual repositories 110, 120, 130—e.g., the people who are responsible for creating, modifying, maintaining, or managing the data objects in those repositories—may be reluctant to give up control of their data objects. For example, if the repository 110 is used to store data objects that are created, maintained, and used at a particular plant within a company, the managers of that plant may not be willing to allow those data objects to be moved to a repository at the company's headquarters, particularly if the data objects are critical to the operation of the plant.

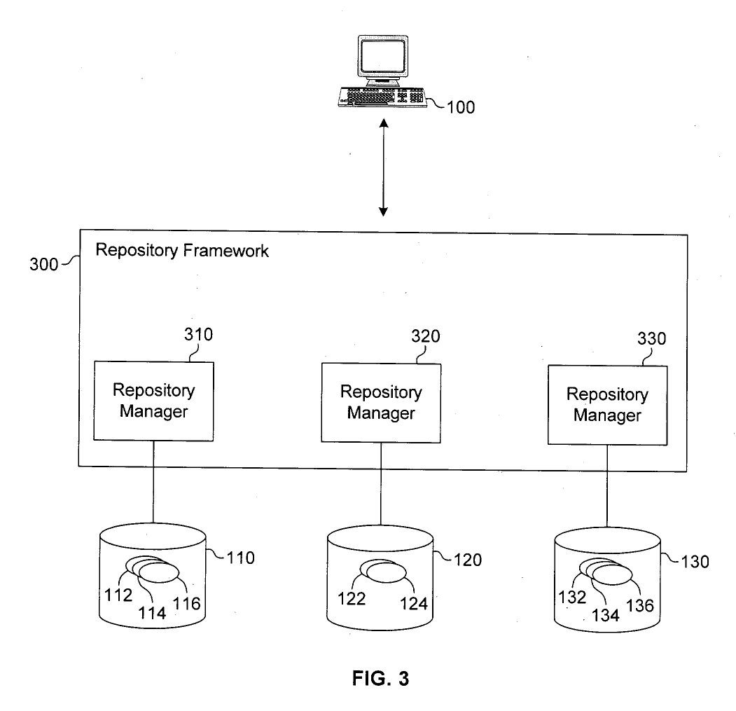

FIG. 3 shows an alternative system for storing and accessing data objects. In the system in FIG. 3, the data objects 112, 114, 116, 122, 124, 132, 134, and 136 are left in their respective repositories 110, 120, and 130. The system features a repository framework 300 that may provide some of the advantages of a central repository. In particular, the repository framework 300 may provide unified navigation, services, and access to data objects stored in multiple disparate repositories.

The repository framework 300 features three repository managers 310, 320, 330 to manage the corresponding repositories 110, 120, 130. A repository manager may be thought of as a connector to a repository. A repository manager may control the operation of a repository and provide access to the data objects in the repository.

A repository framework 300 may come with preconfigured repository managers. For example, a repository manager could be preconfigured to provide a connection to a network file system (NFS). In a system with an NFS repository, a preconfigured NFS repository manager could be instantiated to manage the NFS repository.

A configuration framework may work in conjunction with a repository framework 300 in order to connect the repositories in a knowledge management system. For example, a configuration framework may contain a repository manager for an NFS repository and a repository manager for a Microsoft Exchange mail server. In the example in FIG. 3, a system survey may reveal that the repositories 110 and 120 are NFS repositories, and that the repository 130 is an Exchange repository. In such a scenario, the configuration framework may instantiate two NFS repository managers 310, 320 to manage the corresponding NFS repositories 110, 120, as well as one Exchange repository manager 330 to manage the Exchange repository 130. In some implementations, a development kit may be offered to allow users to develop repository managers for repositories which do not have a preconfigured repository manager.

The repository framework 300 may provide a unified name space for the data objects stored in the individual repositories 110, 120, 130. Each data object may be provided a unique name or reference in a unified name space. The unified name space may be a hierarchical name space in which prefix or first portion of each reference identifies the repository in which the corresponding data object is stored. Table 2 below shows sample names that may be assigned to the data objects in repositories 110 and 120.

TABLE 2

| data | | |
|---|---|---|
| object | name in native repository | name in unified name space |
| 112 | /root/directory_1/file_1 | /nfs_1/directory 1/file_1 |
| 114 | /root/directory_1/file_2 | /nfs_1/directory 1/file_2 |
| 116 | /root/directory_2/file_1 | /nfs_1/directory 2/file_1 |
| 122 | /root/directory_1/file_1 | /nfs_2/directory 1/file_1 |
| 124 | /root/financials/balance_sheet | /nfs_2/financials/balance_sheet |

In the example in FIG. 3 and Table 2, a unified name space is created by assigning each data object a name that begins with a prefix portion that corresponds to the repository in which the data object is located. The end of each data object's native name (i.e., the name that each repository assigns to its own data objects) is then used as the end portion of the data object's name in the unified name space. This naming technique preserves the directory structure in the individual repositories.

The assignment of names in a unified name space may occur, for example, when a new repository is connected to a knowledge management system and a repository manager is instantiated to manage the new repository. When the new repository is registered with the knowledge management system, a name may be assigned to the repository, and that name may then be used as the prefix portion in the names assigned to the data objects that are stored in the repository. Alternative implementations may use different naming techniques. For example, each data object may be provided a sequential serial number.

In some implementations, users may assign data objects new names, as well as group data objects into groups or collections. The collections may be nested within each other, thereby creating a virtual hierarchy. The names in a hierarchical unified name space may not necessarily reflect the actual object names or hierarchies in the repositories in which the objects are stored. Users may alter the virtual hierarchy through operations such as creating or deleting groups, and renaming, moving, copying, or deleting data objects.

For example, a user may want to group data objects 114 and 116 together. The user may thus create a new collection with the name “nfs_{—}1/new_collection,” and specify that the new collection is to store data objects 114 and 116. In this case, data objects 114 and 116 may be accessed through the new collection. The user may also change the names of data objects 114 and 116 to reflect the new grouping. For example, the user may change the names of data objects 114 and 116 to “nfs_{—}1/new_collection/file_{—}1,” and “nfs_{—}1/new_collection/file_{—}2.” In this example, the virtual hierarchy in the unified name space does not reflect the actual hierarchical structure of the repository in which the data objects are stored.

The repository framework 300 may map the names given to data objects in the unified name space to the actual names given to the objects in the individual repositories. The mapping may be very simple—for example, if the prefix portion of the name of a data object corresponds to the name of the repository in which the data object is stored, the prefix portion may simply be deleted.

The mapping may also be more complicated. For example, a mapping may include an indication of the repository in which a data object is located, as well as the actual name given to the object in that repository. For example, a mapping may indicate that data object 112 is stored in repository 110, and that the name given to data object 112 in that repository is “/root/directory_{—}1/file_{—}1.” The benefit of such a mapping is that it may enable users to access data objects without knowing the locations of the objects (i.e., the repositories in which the objects are stored). Users may simply access objects by referencing the names given to the objects in the unified name space. The repository framework 300 may route the users' requests to the appropriate repository by referencing the mapping, which, given a name in the unified name space, may indicate the repository in which the corresponding object is stored. For example, the data object 112 may be moved to repository 120 while its name in the unified name space may stay the same. In this scenario, the mapping may be updated to indicate the new repository in which the data object is located (in this case, repository 120), as well as the actual name given to the object in the new repository.

The repository framework 300 may also provide a uniform interface through which users can access data objects in multiple repositories. The uniform interface may include an application programming interface (API) that specifies the operations that may be used to access the data objects. The operations may include any content management functions, as discussed below. The uniform interface may also specify the results of the operations and the format in which those results are returned.

A request to access a data object may indicate the name of the object to be accessed (e.g., the name given to the object in the unified name space), as well as an operation to be performed on the object (e.g., an operation specified in the uniform interface). When the repository framework 300 receives such a request, it may determine in which repository the relevant object is stored, as well as the name given to the object in that repository (e.g., by mapping the name of the object in the virtual name space to the repository in which the object is stored and to the name given to the object in that repository). The repository framework 300 may then forward the request to the repository manager that corresponds to the relevant repository. That repository manager may then translate the requested operation (e.g., by mapping the requested operation from the uniform interface into a repository-specific operation). The repository manager may then execute the repository-specific operation on the relevant data object. When the repository manager receives the results of the repository-specific operation, it may then map those results into a format specified in the uniform interface, and return the mapped results back to a user computer 100.

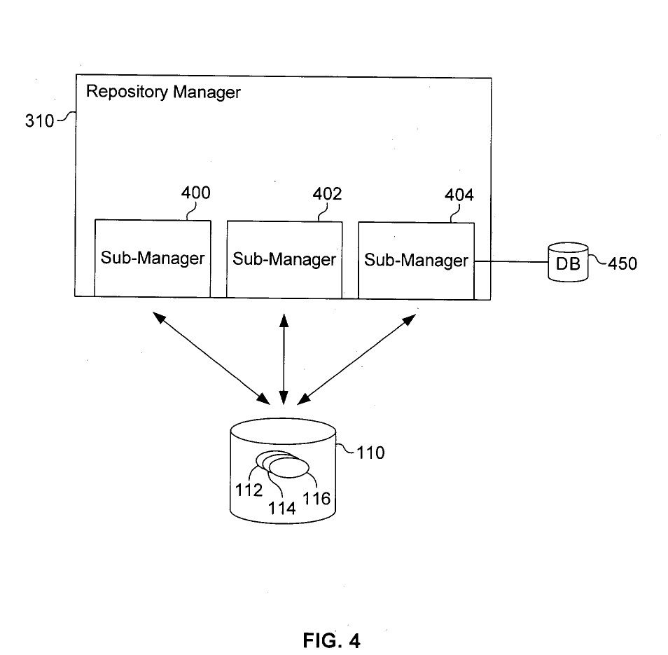

A repository manager 310 may include multiple repository sub-managers 400, 402, 404, as shown in FIG. 4. Each sub-manager 400, 402, 404 may be responsible for a task or a set of tasks related to different aspects of content management.

For example, a “content” sub-manager may be responsible for operations related to accessing the actual content of data objects (e.g., determining the type of the content, determining the length of the content, and retrieving the actual content).

A “properties” sub-manager may be responsible for operations related to creating and maintaining meta-data information about objects (e.g., the author, the creation date, the last editor, and the last access time).

A “name space” sub-manager may be responsible for name space-related operations (e.g., renaming, deleting, copying, or moving data objects or collections of data objects).

A “lock” sub-manager may be responsible for operations related to concurrency control (e.g., locking or unlocking objects with exclusive, shared-access, or other types of locks).

A “versioning” sub-manager may be responsible for operations related to creating and maintaining different versions of data objects (e.g., checking data objects in or out).

A “security” sub-manager may be responsible for operations related to authorization (e.g., creating, maintaining, and using access control lists to control access to data objects).

Each sub-manager maybe responsible for translating one or more operations specified in the uniform interface into one or more repository-specific operations. For example, a uniform interface may specify that the operation to determine the last time a data object was accessed is named “last_access( ),” and that the operation takes one input parameter—a string that contains the name of the relevant data object. In the example in FIG. 4, sub-manager 400 may be a property sub-manager. When repository manager 310 receives an access request that specifies the operation “last_access( )”, repository manager 310 tenders the request to sub-manager 400, since “last_access( )” is a property-related request. Table 1 shows that the repository-specific operation that corresponds to “last_access( )” for repository 110 is an operation named “get_access_time( )” that takes the string name of an object as input. Accordingly, in this example, sub-manager 400 simply has to translate a request to perform an operation such as “last_access(object_name)” into the repository-specific operation “get_access_time(object_name).”

An operation specified in a uniform interface may in some instances be mapped into more than one repository-specific operation. For example, the property sub-manager for repository manager 320 (which manages repository 120) may map the operation “last_access(object_name)” into two repository-specific operations—“get_integer_reference(object_name),” followed by “last_access(id),” where “id” is the integer returned by the first operation. Two operations are needed in this instance because the repository-specific operation “last_access( )” for repository 120 takes as input an integer reference, as shown in Table 1. Thus, in this example, repository manager 320 must map the “object_name” parameter into a corresponding integer parameter, and then invoke the corresponding repository-specific operation for determining the last time of access with the integer parameter.

In some implementations, sub-managers need not be provided for all the operations specified in the uniform interface of a repository framework. In such implementations, a user request may specify an operation for which there is no sub-manager that can handle that operation. For example, a user may send a request specifying an operation to add a certain user to a certain data object's access control list. However, the repository manager that stores that data object may not have a security sub-manager, and thus may not be able to provide any security functionality for the data objects stored in the corresponding repository. In such a situation, the repository manager may simply raise an exception or return an error code indicating that the requested operation is not supported for the data object of interest.

In one implementation, the only operation that must be implemented by every repository manager is a lookup operation that takes a reference to a data object as input and returns a handle to the data object. The object handle can then be provided as input to other, optional operations (i.e., operations that may be performed by some repository managers but not others). Other implementations may require repository managers to implement a larger minimum set of functionality. For example, repository managers may be required to implement, at minimum, a name space sub-manager, a property sub-manger, and a content manager. Other sub-managers such as lock, versioning, and security sub-managers may then be optionally implemented for certain repositories.

A certain type of sub-manager may be implemented as part of a repository manager when the repository that is controlled by the repository manager provides functionality that corresponds to the tasks for which the sub-manager is responsible. For example, if a repository provides access control list functionality, a security sub-manager may readily be implemented to translate the access control list operations specified in a uniform interface into the corresponding repository-specific operations.

However, a sub-manager may also be implemented as part of a repository manager when the repository that is controlled by the repository manager does not provide any functionality that corresponds to the tasks for which the sub-manager is responsible. Such sub-managers may be used to enhance the functionality provided by individual repositories.

For example, in FIG. 4, assuming that repository 110 does not provide any native access control list functionality, a security sub-manager 404 may nevertheless be implemented as part of repository manager 310. The security sub-manager 404 may implement access control list operations by creating and maintaining a table in a database 450 that lists the users who are authorized to access each data object stored in the repository 110. The repository manager 310 may then check requests to access data objects in the repository against the entries in the table before allowing such requests to be processed. In this way, repository manager 310 may provide access control list functionality for the data objects in repository 110 despite the fact that such functionality is not included in the repository itself.

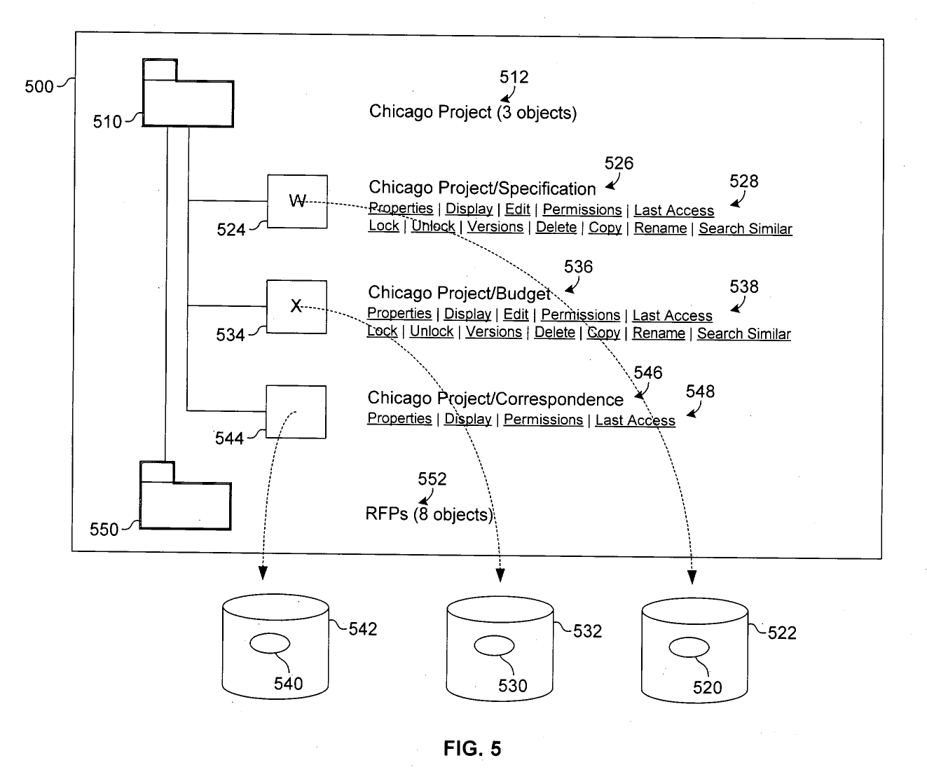

FIG. 5 shows a user interface 500 of an application that a user may execute on user computer 100. The application may allow the user to access data objects 520, 530, 540 stored in disparate repositories 522, 532, 542. The user interface 500 displays a virtual hierarchy that includes two folders 510, 550 that represent two sets or collections of data objects. The first collection is named “Chicago Project” (512), and it contains 3 objects. The second collection is named “RFPs” (552), and it contains 8 objects (not shown).

The first data object 520 in the “Chicago Project” collection is represented by an icon 524 that represents the format of the data object (in this case a Microsoft Word document). The data object 520 may be referred to by the name “Chicago Project/Specification” (526) in the unified name space created by the repository framework 300. The data object 520 is a document which is located in repository 522 (which may be, e.g., a Microsoft DOS repository), and which may be named, for example, “C:\docs\spec.doc” in that repository, but the user can access the data object 520 by referring to its name 526 in the unified name space.

Similarly, the second data object 530 in the “Chicago Project” collection is represented by an icon 534 that represents the format of the data object (in this case a Microsoft Excel document). The object 530 may be referred to by the name “Chicago Project/Budget” (536) in the unified name space. The data object 530 may be located in a completely different repository than the data object 520 (e.g., NFS repository 532), and may be named something like “/users/bsmith/2002budget/chicago.xls” in that repository, but again, the user can access the data object by simply referring to its name 536 in the unified name space.

Continuing with the example in FIG. 5, the third data object 540 is a file in an electronic mail repository 542. The data object 540, which is represented by the icon 544, may be referred to by the name “Chicago Project/Correspondence” (546) in the unified name space.

The user interface 500 displays the operations in the uniform interface provided by the repository framework 300 that may be used to access the data objects 520, 530, 540. A user may access data object 520 through the underlined functions 528, data object 530 through the underlined functions 538, and data object 540 through the underlined functions 548.

For example, the user may want to lock data object 520 so that he can edit the document. The user may click on the “Lock” link in the function group 528. The application may then present the user with a drop-down box that lets the user select between an exclusive lock or a shared lock. The user can select the type of lock he desires and send the request to the repository framework 300. The repository framework 300 may then determine the location and name of the data object 520 (e.g., repository 522 and “C:\docs\spec.doc”), and forward the request to the repository manager that controls repository 522. The repository manager may submit the request to a lock sub-manager, which may map the uniform lock operation into the corresponding repository-specific operation, and execute the latter operation within repository 522. The repository manager may then map the return value of the repository-specific operation into the return value specified for the lock operation in the uniform interface, and return that value to application, which may, for example, display a lock graphic on top of icon 524 to show that the user has successfully obtained a lock for data object 520.

Function group 548 in FIG. 5 lists fewer operations than function groups 538 and 528, which indicates that the repository manager for repository 542 may have fewer sub-managers implemented than the repository managers for repositories 532 and 522. A number of functions that may be available for data objects in repositories 532 and 522 (e.g., “Lock” and “Unlock”) may therefore not be available for data objects in repository 542.

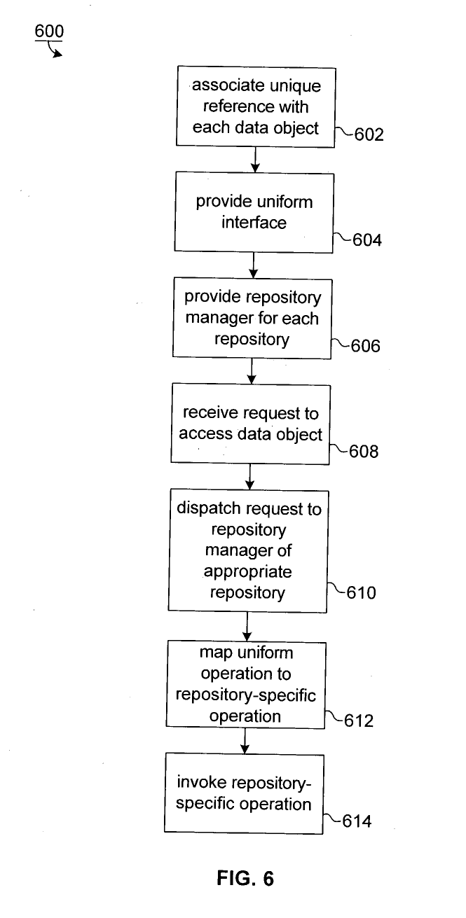

FIG. 6 is a flowchart of a process 600 that may be used to provide access to data objects in disparate repositories. A unique name or reference is first associated with each data object (602) so as to create a unified name space. The unified name space may be hierarchical if, for example, the data objects are organized into nested or hierarchically arranged collections.

A uniform interface is then provided (604). The interface may specify the name of operations that can be used to access the data objects. The interface may also specify the name, number, and format of input parameters to be provided to the operations in the uniform interface, as well as the name, number, and format of the return values that can be returned by the operations.

Next, a repository manager is provided to control the operation of each repository (606). When a request to access a data object is received from a user (608), the request is dispatched to the repository manager that controls the repository in which the data object is stored (610). Determining to which repository manager an access request should be sent may involve mapping the name of the data object in the request, which may be a name in the unified name space, into an identification of the repository in which the object is stored and the name given to the data object in that repository.

The repository manager may then map the operation in the request, which may be specified as an operation in the uniform interface, into a repository-specific operation (612). The repository manager may, for example, look up the name of the repository-specific operation or set of operations that correspond to the operation in the uniform interface. The repository manager may also need to reformat or rearrange the parameters specified in the request in order to match the format required by the repository-specific operation. The repository manager may also have to add or delete parameters, and may need to invoke additional operations in order to determine the values to be assigned to additional parameters.

The repository-specific operation or set of operations may then be invoked to carry out the requested operation on the requested data object (614). If the repository-specific operation or operations produce any return values, the return values may be reformatted or restructured into a format or structure specified in the uniform interface, and then returned to the user.

The systems and techniques described herein may be enhanced in various ways. For example, the repository managers or other components in the repository framework may implement caches to shorten the time required to access frequently used data objects. An eventing mechanism may be implemented to allow repository managers to trigger events or to send each other events. Such a mechanism may facilitate certain operations, such as moving data objects in-between repositories. A repository framework may also be combined with other services that can be offered through knowledge management systems, such as searching and retrieving, indexing, publishing, and building classifications or taxonomies. In this manner, users may be able to take advantage of such services while still realizing the benefits provided by the systems and techniques described herein (e.g., a unified name space, a uniform interface, and the ability to access data objects without necessarily knowing their location or format).

Various implementations of the systems and techniques described here can be realized in digital electronic circuitry, integrated circuitry, specially designed ASICs (application-specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device. Such computer programs (also known as programs, software, software applications or code) may include machine instructions for a programmable processor, and may be implemented in any form of programming language, including high-level procedural and/or object-oriented programming languages, and/or in assembly/machine languages. A computer program may be deployed in any form, including as a stand-alone program, or as a module, component, subroutine, or other unit suitable for use in a computing environment. A computer program may be deployed to be executed or interpreted on one computer or on multiple computers at one site, or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; CD-ROM and DVD-ROM disks; and programmable logic devices (PLDs). The processor and the memory can be supplemented by, or incorporated in special purpose logic circuitry.

As used herein, the term “machine-readable medium” refers to any computer program product, apparatus, and/or device used to provide machine instructions and/or data to a programmable processor, including any type of mass storage device or information carrier specified above, as well as any machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a cathode ray tube (CRT) or liquid crystal display (LCD) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., a database or a data server), a middleware component (e.g., an application server), or a front-end component (e.g., a client computer having a user interface, such as a graphical user interface or a Web browser, through which a user can interact with an implementation of the systems and techniques described herein), or any combination of such back-end, middleware, or front-end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

The processes and logic flows described herein may be performed by one or more programmable processors executing a computer program to perform the functions described herein by operating on input data and generating output. The processes and logic flows may also be performed by, and the systems and techniques described herein may be implemented as, special purpose logic circuitry, e.g., a field programmable gate array (FPGA) or an ASIC.

The invention has been described in terms of particular embodiments. Other embodiments are within the scope of the following claims. For example, the logic flow depicted in FIG. 6 does not require the particular order shown, or sequential order, to achieve desirable results. For example, providing a repository manager for each repository and implementing repository sub-managers may be performed at many different places within the overall process. In certain implementations, multitasking and parallel processing may be preferable. Other embodiments may be within the scope of the following claims.

What is claimed is:

1. A knowledge management system comprising:
a plurality of repositories, each repository comprising data objects; and
a repository framework comprising a plurality of repository managers, each repository manager configured to provide access to an associated repository, said repository framework comprising a uniform interface for accessing the data objects in the repositories and providing a unified name space comprising a unique reference for each data object.

2. The system of claim 1, wherein the uniform interface comprises an operation, wherein at least one repository comprises a repository-specific operation that corresponds to the operation specified in the uniform interface, and wherein the repository manager that is associated with the at least one repository is adapted to map the operation specified in the uniform interface to the corresponding repository-specific operation.

3. The system of claim 2 wherein the operation specified in the uniform interface is a name space operation.

4. The system of claim 2 wherein the operation specified in the uniform interface is a property operation.

5. The system of claim 2 wherein the operation specified in the uniform interface is a content operation.

6. The system of claim 2 wherein the operation specified in the uniform interface is a locking operation.

7. The system of claim 2 wherein the operation specified in the uniform interface is a versioning operation.

8. The system of claim 2 wherein the operation specified in the uniform interface is a security operation.

9. The system of claim 1, wherein the uniform interface comprises a plurality of operations, wherein at least one repository comprises a repository-specific interface, the repository-specific interface comprising a plurality of repository-specific operations, and wherein the repository manager that is associated with the at least one repository comprises a plurality of sub-managers, each sub-manager adapted to map at least one operation specified in the uniform interface to at least one repository-specific operation.

10. The system of claim 1, wherein at least one repository comprises a repository-specific interface, the repository-specific interface comprising a plurality of repository-specific operations, wherein the uniform interface comprises an operation that does not correspond to any operation in the plurality of repository-specific operations, and wherein the repository manager that is associated with the at least one repository comprises an implementation of the operation in the uniform interface that does not correspond to any operation in the plurality of repository-specific operations.

11. The system of claim 1 wherein the data objects are organized into at least two collections.

12. The system of claim 11 wherein the collections are arranged in a hierarchy.

13. The system of claim 1 wherein the data objects comprise structured documents.

14. The system of claim 1 wherein the data objects comprise unstructured documents.

15. The system of claim 1 wherein the data objects comprise semi-structured documents.

16. The system of claim 1 wherein the data objects comprise a combination of structured documents, unstructured documents, and semi-structured documents.

17. A method for providing access to data objects stored in a plurality of repositories, the method comprising:
associating a unique reference in a unified name space with each data object;
providing a repository manager to provide access to an associated repository;
receiving a request to access a data object in one of the repositories, the request comprising the unique reference associated with the data object;
determining the repository in which the data object is stored based on the unique reference in the request; and
dispatching the request to the repository manager that is associated with the repository in which the data object is stored.

18. The method of claim 17 further comprising providing a uniform interface for accessing the data objects.

19. The method of claim 18, wherein the uniform interface comprises a plurality of operations, and wherein the request specifies one of the operations in the uniform interface.

20. The method of claim 19, wherein the repository in which the data object is stored comprises a plurality of repository-specific operations, and wherein the method further comprises mapping the operation specified in the request to at least one operation in the plurality of repository-specific operations.

21. The method of claim 18, wherein at least one repository comprises a plurality of repository-specific operations, wherein the uniform interface comprises an operation that does not correspond to any operation in the plurality of repository-specific operations, and wherein the method further comprises implementing the operation in the uniform interface for the at least one repository.

22. The method of claim 17 further comprising organizing the data objects into at least two collections.

23. The method of claim 22 wherein the collections are arranged hierarchically.

24. The method of claim 17 further comprising providing an eventing mechanism to enable the repository manager to trigger an event.

25. A machine-readable medium comprising instructions that, when executed, cause a machine to perform operations comprising:
associate a unique reference in a unified name space with each data object in a plurality of data objects, each data object being stored in one of a plurality of repositories;
provide a repository manager to provide access to an associated repository;
receive a request to access a data object in one of the repositories, the request comprising the unique reference associated with the data object;
determine the repository in which the data object is stored based on the unique reference in the request; and
dispatch the request to the repository manager that is associated with the repository in which the data object is stored.

26. The machine-readable medium of claim 25 wherein the operations further comprise:
provide a uniform interface for accessing the data objects.

27. The machine-readable medium of claim 26, wherein the uniform interface comprises a plurality of uniform operations, and wherein the request specifies one of the uniform operations in the uniform interface.

28. The machine-readable medium of claim 27, wherein the repository in which the data object is stored comprises a plurality of repository-specific operations, and wherein the operations performed by the machine further comprise:
map the uniform operation specified in the request to at least one repository-specific operation in the plurality of repository-specific operations.

29. The machine-readable medium of claim 26, wherein at least one repository comprises a plurality of repository-specific operations, wherein the uniform interface comprises a uniform operation that does not correspond to any repository-specific operation in the plurality of repository-specific operations, and wherein the operations performed by the machine further comprise:
implement the uniform operation in the uniform interface for the at least one repository.

30. The machine-readable medium of claim 25 wherein the operations further comprise:
organize the data objects into at least two collections.

31. The machine-readable medium of claim 25 wherein the operations further comprise:
provide an eventing mechanism to enable the repository manager to trigger an event.
